(19) United States
(12) Patent Application Publication
(10) Pub. No.: US 2012/0266207 A1
(43) Pub. Date: Oct. 18, 2012

(54) SET TOP BOX AND POWER MANAGEMENT METHOD THEREOF

(75) Inventors: CHUN-MING CHEN, Tu-Cheng (TW); SHOU-KENG LIN, Tu-Cheng (TW)

(73) Assignee: HON HAI PRECISION INDUSTRY CO., LTD., Tu-Cheng (TW)

(21) Appl. No.: 13/449,291

(22) Filed: Apr. 17, 2012

(30) Foreign Application Priority Data
Apr. 18, 2011 (CN) 201110096819.9

(51) Int. Cl. H04N 21/41

(52) U.S. Cl. 725/151

(57) ABSTRACT

A set top box (STB) constructs a relation table for storing a plurality of playback modes of the STB each corresponding to a certain frequency of the processor, and stores the relation table in a storage medium. The STB starts to time a predetermined time period after the STB is powered on. The STB determines if the STB receives any control signal during the predetermined time period. The STB detects a current playback mode of the STB, obtains a frequency corresponding to the current playback mode of the STB by looking up the relation table, and adjusts the operating frequency of the processor to the required frequency when the STB does not receive any control signal during the predetermined time period.

### BACKGROUND

1. Technical Field

Embodiments of the present disclosure relate to a set top box, and more particularly to a set top box and a power management method thereof.

2. Description of Related Art

A processor of a set top box (STB) runs at the maximum frequency in order to provide real-time responses to requests from users. However, most of the time, users just watch TV and are not interacting with the STB. Thus, power in the STB is being wasted because the processor is always operating at the maximum frequency.

Therefore, a power-saving STB is needed to overcome the aforementioned deficiencies and inadequacies.

### BRIEF DESCRIPTION OF THE DRAWINGS

FIG. 1 is a block diagram of one embodiment of a set top box in accordance with the present disclosure.

FIG. 2 is a schematic diagram of one embodiment of a relation table stored in a storage medium of the set top box.

FIG. 3 is a flowchart of one embodiment of a power management method of the set top box in accordance with the present disclosure.

### DETAILED DESCRIPTION

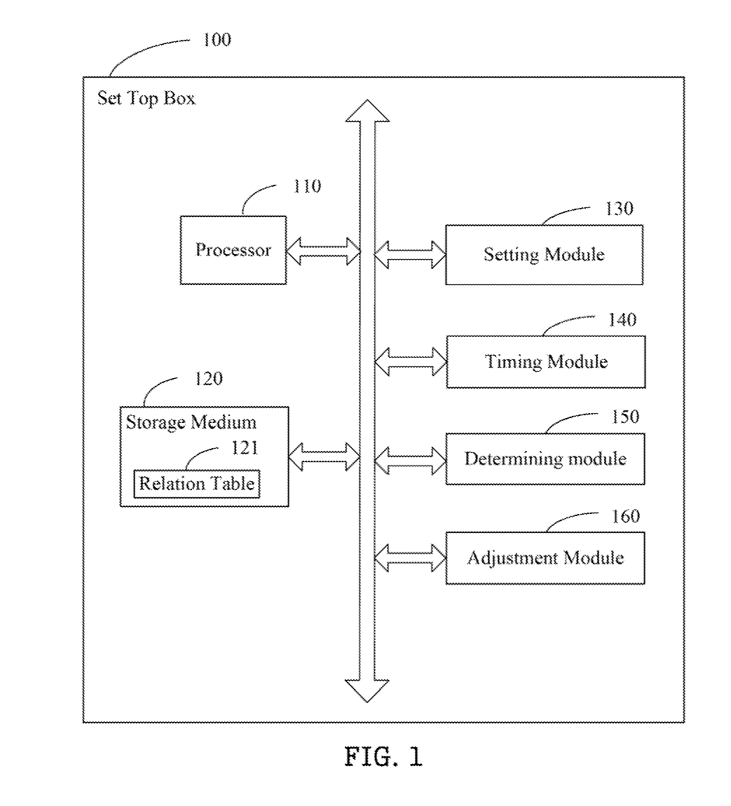

FIG. 1 is a block diagram of one embodiment of a set top box (STB) 100 in accordance with the present disclosure. In one embodiment, the STB 100 includes a processor 110, a non-transitory storage medium 120, a setting module 130, a timing module 140, a determining module 150, and an adjustment module 160.

In general, the word “module”, as used herein, refers to logic embodied in hardware or firmware, or a collection of software instructions, written in a programming language. In one embodiment, the programming language may be Java, or C, or an assembly language. One or more software instructions in the modules may be embedded in firmware. The modules described herein may be implemented as either software and/or hardware modules and may be stored in the storage medium 120 or any other storage medium.

The processor 110 can be a central processing unit (CPU), a video processor, a digital signal processor, or a microprocessor, for example. In one embodiment, the processor 110 can support dynamic frequency scaling. The storage medium 120 includes volatile and non-volatile memory, removable and non-removable medium implemented in any method or technology for storage of information such as computer-readable instructions, data structures, program modules or other data. The storage medium 120 can be a random access memory (RAM), a read only memory (ROM), a flash memory or any other non-transitory media that can be used to store the desired information.

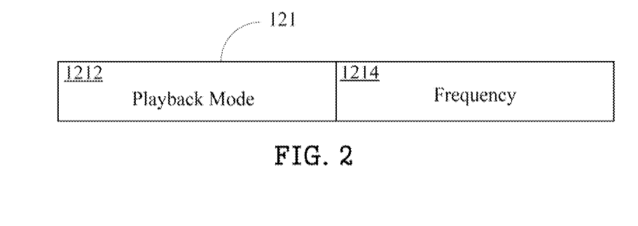

The storage medium 120 stores a relation table 121 that includes various playback modes 1212 of the STB 100 and corresponding frequencies 1214 of the processor 110 as shown in FIG. 2. In the following description, adjustment of operating frequency of the processor 110 to a target frequency comprises enabling the processor 110 to operate at the target frequency. One or more computer executable instructions of the modules 130-160 as hereinafter described may be executed by the processor 110.

In one embodiment, playback modes 1212 of the STB 100 can be categorized into classes, such as “High Definition (HD) Video”, “Standard Definition (SD) Video”, “Audio only” and “Menu only”. The utilization of the processor 110 may change over time depending on the playback modes 1212 and any user interactions with the STB 100. By detecting current playback mode 1212 at runtime, the processor 110 can effectively adjust power management within the STB 100, for example, by adjusting operating frequency. FIG. 2 is a schematic diagram of one embodiment of the relation table 121 stored in the storage medium 120 of the STB 100. The relation table 121 defines relationship between various playback modes 1212 and frequencies 1214 of the processor 110. For example, the relation table 121 may define a relationship that when the playback mode 1212 of the STB 100 is “HD Video”, “SD Video”, “Audio Only” or “Menu Only”, the corresponding frequencies for operating frequency of the processor 110 may be “FULL”, “50%”, “25%” and “12.5%”. For example, “FULL” operating frequency of a theoretical 4 GHz supportive processor is or should approach 4 GHz and “50%” operating frequency of a 4 GHz supportive processor is then 2 GHz. In one embodiment, the relation table 121 can be constructed by the setting module 130 automatically according a specification of the STB 100 when power is on, or can be manually programmed through input from the user via the user interface of the STB 100.

The timing module 140 includes a timer that measures lapse of a predetermined time period T1 after the STB 100 is powered on. In one embodiment, the processor 110 operates at maximum frequency as soon as the STB 100 is powered on. The determining module 150 determines whether the STB 100 receives any control signal within the predetermined time period T1. In one embodiment, the STB 100 can receive control signals, such as infrared (IR) signals from a remote control operated by a user. If any control signal is received by the STB 100 within the predetermined time period T1, the adjustment module 150 retains operating frequency of the processor 110 in order to provide real-time responses to the user's requests and the timing module 140 restarts the timing of the predetermined time period T1 whenever a control signal is received. If the STB 100 does not receive any control signal within the predetermined time period T1, for example, because the user does not interact with the STB 100 via the remote control, the adjustment module 160, at the expiry of the predetermined time period T1, detects current playback mode 1212 of the STB 100, looks up frequency 1214 which corresponds to it in the relation table 121 and adjusts operating frequency of the processor 110 to the related and required frequency 1214. For example, if current playback mode 1212 of the STB 100 is “SD Video”, the adjustment module 160 adjusts operating frequency of the processor 110 to 50% of the maximum frequency. If current playback mode 1212 of the STB 100 is “Audio Only”, the adjustment module 160 adjusts operating frequency of the processor 110 to 25% of a maximum frequency. Thus, operating frequency of the processor 110 is adjusted to apply a higher or lower frequency which is appropriate for the current playback mode 1212 of the STB 100.

The determining module 150 also determines whether current playback mode 1212 of the STB 100 is changed by the user via the remote control or whether the STB 100 receives an updated electronic program guide (EPG). In one embodiment, the EPG provides the user of the STB 100 with continuously updated menus displaying current and upcoming television programs on all available channels. The EPG allows the user to select a program using the remote control. If the user changes current playback mode 1212 or the STB 100 receives an updated EPG, the adjustment module 160 adjusts operating frequency of the processor 110 to the maximum frequency and the timing module 140 restarts the timer to begin timing the predetermined time period T1 again. The ability of the adjustment module 160 to adjust operating frequency of the processor 110 to the maximum frequency is not restricted to apply only for changes of current playback mode 1212 by the user or reception of an updated EPG. Further, the adjustment module 160 may adjust operating frequency of the processor 110 to the maximum frequency in response to any control signal has been received by the STB 100. If no control signal is received by the STB 100, the adjustment module 160 retains the current operating frequency of the processor 110. For example, if current playback mode 1212 of the STB 100 is “SD only” and no user request to change current playback mode 1212 via the remote control is received, and no updated EPG is received by the STB 100, the adjustment module 160 does not change operating frequency of the processor 110, it is retained at 50% of the maximum frequency. As described above, operating frequency of the processor 110 is not reduced to a level less than the particular frequency 1214 which corresponds to current playback mode 1212 and the processor 110 does not constantly run at maximum operating frequency, thus power consumption is reduced.

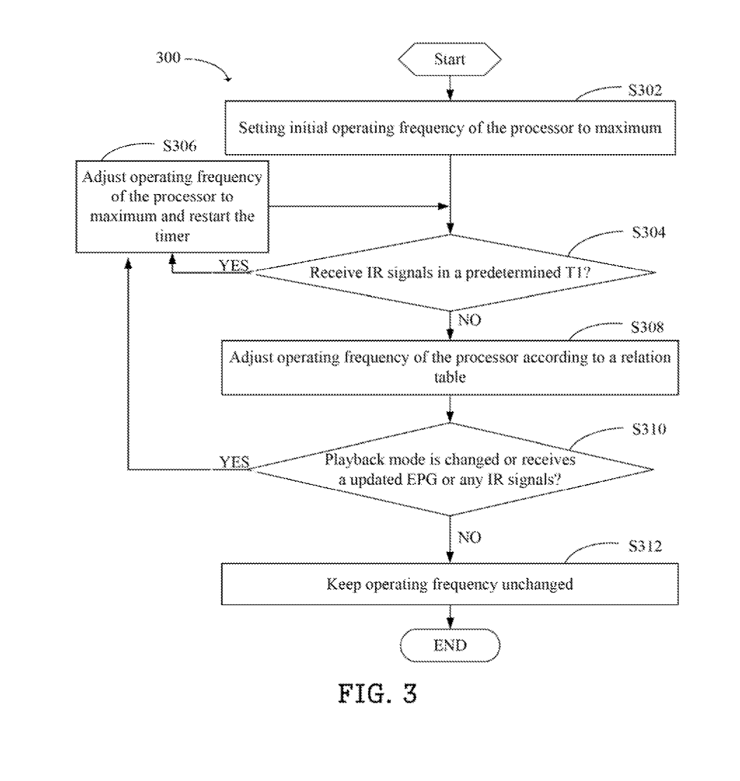

FIG. 3 is a flowchart 300 of one embodiment of a power management method of the STB 100. In one embodiment, all steps in the flowchart 300 are performed by modules 130-160 disclosed in FIG. 1.

When the STB 100 is powered on, in step S302, the adjustment module 160 adjusts initial operating frequency of the processor 110 to the maximum frequency. For example, the activated adjustment module 160 may adjust operating frequency of the 4 GHz supportive processor 110 to the maximum frequency of 4 GHz. The setting module 130 constructs the relation table 121 that defines various playback modes 1212 of the STB 100 and frequencies 1214 of the processor 110 to correspond with each of the playback modes 1212 and stores the relation table 121 in the storage medium 120. The timing module 140 starts to time the predetermined time period T1 when the STB 100 is powered on. In step S304, a determination is made by the determining module 150 that a control signal has been received by the STB 100, e.g., an IR signal, from the user via the remote control within the predetermined time period T1, whereupon the process moves to step S306. In step S306, the adjustment module 160 does not change operating frequency of the processor 110, but the timing module 140 restarts the timer to begin timing the predetermined time period T1 again, whereupon the procedure returns to step S304. If the STB 100 does not receive any control signal within the predetermined time period T1, then in step S308, the adjustment module 160 detects current playback mode 1212 of the STB 100, looks up corresponding frequency 1214 in the relation table 121 and if necessary adjusts operating frequency of the processor 110 to the related and required frequency 1214. After adjusting operating frequency of the processor 110, the process moves to step S310, in which the determining module 150 makes a determination either that the current playback mode 1212 of the STB 100 has been changed by the user via the remote control, or that the STB 100 has received an updated EPG or any control signal has been received at the STB 100 that needs the processor 110 to operate at maximum frequency. If the user requests and inputs a change in the current playback mode 1212 or the STB 100 receives an updated EPG or a control signal, step S306, the adjustment module 160 adjusts operating frequency of the processor 110 to the maximum frequency and the timing module 140 restarts the timer to begin timing the predetermined time period T1 again. When the predetermined period of time T1 has expired the process returns to step S304.

For example, the user may select a SD channel to view after powering on the STB 100. If the channel selection is done within the predetermined time period T1, the adjustment module 160 keeps the processor 110 operating at maximum frequency and the timing module 140 restarts the timer to begin timing the predetermined time period T1 again. If the user does not interact with the STB 100 via the remote control within the predetermined time period T1, and the adjustment module 160 detects that current playback mode 1212 is “SD Video”, the relation table is looked up to obtain corresponding frequency for “SD Video”, which is 50% of the maximum frequency, and adjusts operating frequency of the processor 110 to 50% of the maximum frequency. After viewing a SD channel for some time, the user may navigate the EPG to select other channel via the remote control. When a further control signal from the remote control is recognized as such by the determining module 150, the adjustment module 160 adjusts operating frequency of the processor 110 to the maximum frequency and the timing module 140 restarts the timer.

In conclusion, the frequency of the processor 110 is adjusted up and down depending on the type of media being processed by the STB 100. Because power usage is a function of frequency of the processor 110, dynamic frequency scaling means that power is used more efficiently. By the intelligent adjustment of frequency of the processor 110 to an appropriate level, power consumption of the STB 100 is reduced with no adverse effect on performance.

The foregoing disclosure of various embodiments has been presented for purposes of illustration and description. It is not intended to be exhaustive or to limit the disclosure to the precise forms disclosed. Many variations and modifications of the embodiments described herein will be apparent to one of ordinary skill in the art in light of the above disclosure. The scope of the disclosure is to be defined only by the claims appended hereto and their equivalents.

What is claimed is:

1. A set top box, comprising:
a processor;
a storage medium storing one or more programs executable by the processor, the one or more programs comprising:
a timing module timing according to a predetermined time period;
a determining module determining whether the set top box receives a control signal from a remote control within the predetermined time period; and
an adjustment module adjusting an operating frequency of the processor to a first frequency, and enabling the processor to operate at the first frequency if the set top box receives the control signal within the predetermined time period.

2. The set top box of claim 1, further comprising a setting module constructing a relation table stored in the storage medium that defines relationships between a plurality of playback modes of the set top box and a plurality of operating frequencies of the processor.

3. The set top box of claim 2, wherein the adjustment module further detects a current playback mode of the set top box, obtains a second frequency corresponding to the current playback mode in the relation table, and adjusts the operating frequency of the processor to the second frequency if the set top box does not receive any control signal in the predetermined time period.

4. The set top box of claim 1, wherein the first frequency is equal to a maximum operating frequency of the processor.

5. The set top box of claim 3, wherein the first frequency is higher than the second frequency.

6. The set top box of claim 3, wherein the determining module further determines whether the current playback mode is changed or whether the set top box receives an updated electronic program guide.

7. The set top box of claim 6, wherein after adjusting the operating frequency of the processor according to the second frequency, the adjustment module further adjusts the operating frequency of the processor to the first frequency, and enables the processor to operate at the first frequency if the current playback mode is changed or the set top box receives an updated electronic program guide.

8. A power management method executable by a set top box comprising a processor and a storage medium, comprising:
timing according to a predetermined time period after the set top box is powered on;
determining whether the set top box receives a control signal from a remote control within the predetermined time period; and
adjusting an operating frequency of the processor to a first frequency, and enabling the processor to operate at the first frequency if the set top box receives the control signal within the predetermined time period.

9. The method of claim 8, further comprising constructing and storing a relation table in the storage medium that defines relationships between a plurality of playback modes of the set top box and a plurality of operating frequencies of the processor.

10. The method of claim 9, further comprising:
detecting a current playback mode of the set top box;
obtaining a second frequency corresponding to the current playback mode in the relation table; and
adjusting operating frequency of the processor to the second frequency if the set top box does not receive any control signal in the predetermined time period.

11. The method of claim 8, wherein the first frequency is equal to a maximum operating frequency of the processor.

12. The method of claim 10, wherein the first frequency is higher than the second frequency.

13. The method of claim 10, further comprising:
determining whether the current playback mode is changed or whether the set top box receives an updated electronic program guide.

14. The method of claim 11, further comprising:
adjusting the operating frequency of the processor to the first frequency if the current playback mode is changed or the set top box receives an updated electronic program guide.
